(19) United States
(12) Patent Application Publication
(10) Pub. No.: US 2007/0239586 A1
(43) Pub. Date: Oct. 11, 2007

(54) System and methd of rebalancing a portfolio of separately managed accounts

(75) Inventors: Neil Inala, Chestnet Hill, MA (US); Ian Dembsky, Braintter, MA (US); Zachary Hildebrandt, Ipswich, MA (US); Paul Ma, Culver City, MA (US)

Correspondence Address: ROTHWELL, FIGG, ERNST & MANBECK, P.C., 1425 K STREET, N.W., SUITE 800, WASHINGTON, DC, 20005, US

(73) Assignee: ITG Software Solutions, Inc., Culver City, CA (US)

(21) Appl. No.: 11/727,397

(22) Filed: Mar. 26, 2007

Related U.S. Application Data
(60) Provisional application No. 60/785,367, filed on Mar. 24, 2006.

(51) Int. Cl. G06Q 40/00

(52) U.S. Cl. 705/36 R

(57) ABSTRACT

A system and method for rebalancing separately managed accounts utilizing sub-models. Sub-models can be generated automatically by analyzing the restrictions that exist on the individual accounts, or created manually by identifying particular stocks that might fall within a particular industry, sector or other arbitrary classification. An account can be classified as belonging to one or more sub-models. These sub-models allow for a more efficient rebalancing process by allowing transaction decisions to be made according to a particular sub-model rather than at the level of each individual account. These sub-models also allow for more efficient monitoring of large numbers of accounts by allowing analysis of account drift according to both restrictions associated with the account as well as the account's master model portfolio, rather than solely relative to the account's master model portfolio without incorporating the account's restrictions.

### CROSS-REFERENCE TO RELATED APPLICATIONS

This application claims the benefit of priority to U.S. Provisional Patent Application No. 60/785,367 filed on Mar. 24, 2006, the entire contents of which is incorporated herein by reference.

### BACKGROUND OF THE INVENTION

1. Field of the Invention

The present invention is generally directed to systems and methods for managing wealth. More particularly, the present invention relates to systems and method for efficiently and effectively rebalancing portfolios held by a plurality of individual investment accounts in response to one or several investment decisions.

2. Summary of the Related Art

Portfolio managers and money managers manage money and assets for others. Portfolio managers work for investment management firms and spend their time researching financial trading markets and business sectors in order to make expert investment decisions for their managed portfolios. A managed portfolio will serve as a model portfolio for aggregations of arbitrary numbers of individual accounts, quite possibly hundreds or thousands of accounts or even more, each account having holdings composed of a set of positions in various assets, such as securities or cash or other financial instruments.

Managed accounts (also called SMAs or “wrap” accounts) are often managed in groups. Portfolio managers give individual account holders the opportunity to select an investment strategy for their account and/or allow the account holder to set rules or restrictions for their account. As a result, in practice, many accounts in a same portfolio will follow identical investment strategies while other accounts will differ from that strategy, slightly or by a lot, due to one or more restrictions.

A portfolio manager for a separately managed account usually does not make decisions for each account individually, on a day-to-day basis. Instead, a portfolio manager makes decisions for the model portfolio that serves as an exemplar for each account's individual portfolio. Such decisions are sometimes called “investment insights” or simply “insights.” The portfolio manager will determine a list of holdings that serve as the best possible representative of the portfolio manager's insights. Once this list of securities or financial instruments has been decided upon, it is represented as a “model portfolio”. A model portfolio may also be called simply a “model” or a “benchmark” or “benchmark portfolio”.

A portfolio manager's insights indicate the model portfolio but do not indicate how to adjust individual accounts within the portfolio. Adjusting individual accounts is called ‘rebalancing’. Rebalancing means to buy or sell securities for an account's portfolio to bring those securities into an alignment that is as close as possible to the model portfolio recommended for that account. Each individual account must be rebalanced to correspond as closely as possible to the portfolio manager's investment insights. However, each individual account has restrictions placed upon it and compliance rules that will affect the rebalancing procedure. Accordingly, each account must be separately rebalanced to implement the insights while taking into account the restrictions and compliance rules placed upon it. As a result, the rebalancing of individual accounts in a managed portfolio can be very time consuming and labor intensive. Because it may be desirable to rebalance accounts on arbitrary time scales (yearly, biannually, quarterly, monthly, weekly, daily, continuously or irregularly), an enormous amount of work can go into rebalancing accounts.

Thus, there exists a need for new and improved systems and methods for rebalancing individual accounts within a managed portfolio.

### SUMMARY OF THE INVENTION

The present invention relates to features of a wealth management system for managing a portfolio of individual account holdings.

According to the present invention, ‘sub-models’ can be generated for groups of accounts by incorporating restrictions into existing model portfolios. Sub-models represent model portfolios after securities (and weightings) specified in the model portfolio have been modulated by specific account-level restrictions. As a result, sub-models can be used in place of models for groups of individual accounts that share common sets of restrictions, in order to efficiently and quickly rebalance account portfolios. While the securities and/or security weightings described in a sub-model are usually slightly different from those described by the parent model, they may also in fact be identical to those of the model portfolio; in such a case the sub-model represents an account that follows the model and that has no restrictions.

According to an embodiment of the present invention, a system is provided for portfolio managers to define a particular set of holdings that make up a model portfolio. The portfolio manager's insights are recorded and distributed down to a large number of client accounts that are subscribed to that portfolio manager's particular strategy or model while applying individual restrictions and compliance rules to each of the individual client accounts. Trade orders are generated based on the rebalancing of the individual accounts to effect the rebalancing and implement the insights.

According to an embodiment of the present invention, a system is provided for rebalancing a portfolio that serves as a model for a plurality of individual investment accounts, each individual investment account holding at least one of either tradeable assets or cash. A data storage facility is configured to store data defining each of the plurality of individual investment accounts and restrictions on each of the plurality of individual investment accounts. A modeling facility is configured to receive an investment model and to generate one or more adjusted models based upon the investment model and the restrictions in the data storage facility and to associate each adjusted model to one or more corresponding individual investment accounts. A rebalancing facility is configured to rebalance account holdings in the individual investment accounts based upon corresponding adjusted models from the modeling facility.

According to an embodiment of the present invention, a method is provided for rebalancing a plurality of managed investment accounts based on an investment model, each of the investment accounts including a portfolio of assets and having zero or more restrictions associated therewith. The method includes steps of associating at least one sub-model to a group of the plurality of managed investment accounts, the at least one sub-model defining a group of restrictions (possibly of size zero) that are common to the group of managed investment accounts; receiving an investment model defining a master portfolio; and rebalancing each of the group of managed investment accounts based upon the investment model and the at least one sub-model.

According to an embodiment of the present invention, sub-models are automatically constructed. Once calculated, the sub-models can be stored in a data storage facility (e.g., in a database, or in a file), or used immediately “on-the-fly.” There may be as many as one sub-model for every individual account. Typically, however, sub-models are generated for large groups of accounts having common restrictions. For example, if twenty thousand accounts follow a Large Cap Value model, there may be ten thousand accounts that have restrictions against holding so-called ‘sin stocks’. If these ‘no-sin-stock’ restrictions are the only restrictions on those accounts, the group of accounts can all be viewed as following a ‘sin-free’ variant of the Large Cap Value model. Thus, one sin-free sub-model could be generated for and associated with ten thousand accounts in a portfolio.

According to one embodiment of the present invention, sub-models are constructed automatically by a system that examines account-level restrictions. When encountering a set of restrictions for an account, the system can first search a data store to determine if a sub-model exists that correspond to the combination of the set of restrictions plus the model portfolio. Consequently, the system allows sub-models to be shared across many different accounts. In practice, this search can be implemented in a variety of ways, including calculating a unique indexing number, or encoding sub-model restriction sets as a coded string that compresses the sub-model feature space. If a sub-model already exists for the combination of model and restrictions that is needed, then that sub-model can be loaded and used. If the sub-model does not yet exist, it can be constructed. Occasionally, it may be faster to recreate the submodel dynamically, in computer memory, rather than loading it from a data store. Performance benefits still accrue to the rebalancing algorithm in such a case due to the shared nature of submodels across accounts holding similar groups of restrictions.

According to another embodiment of the present invention, the adjusted models allow analysis of accounts to identify account drift relative to account restrictions, rather than solely relative to the master portfolio model.

Further applications and advantages of various embodiments of the present invention are discussed below with reference to the drawing figures.

### BRIEF DESCRIPTION OF THE DRAWINGS

FIG. 1 is a block diagram of a system for using sub-models to rebalance individual investment accounts according to an embodiment of the present invention.

FIG. 2 is a flow diagram of a process for using sub-models to rebalance individual investment accounts according to an embodiment of the present invention.

FIG. 3 is a screenshot of an exemplary interface of a system for managing models and sub-models.

FIG. 4 is a flow diagram of a process for efficiently using sub-models to rebalance individual investment accounts according to an embodiment of the present invention.

FIG. 5 is a diagram representing the relationship between a model and sub-model according to an embodiment of the present invention.

FIG. 6 is a screenshot of an exemplary interface of a system which allows users to view accounts by deviation from a corresponding model/sub-model.

### DETAILED DESCRIPTION OF THE PREFERRED EMBODIMENTS

While the present invention may be embodied in many different forms, a number of illustrative embodiments are described herein with the understanding that the present disclosure is to be considered as providing examples of the principles of the invention and that such examples are not intended to limit the invention to preferred embodiments described herein and/or illustrated herein.

Wealth management is often concerned primarily with asset allocation. Studies show that proper asset allocation can reduce risk and provide superior returns when done in conjunction with a properly maintained portfolio. In a portfolio management system, a portfolio manager's investment insights are recorded and distributed down to a large number of client accounts that are subscribed to that portfolio manager's particular strategy while applying individual restrictions and compliance rules to each of the individual client accounts. Trade orders are generated based on the rebalancing of the individual accounts to effect the rebalancing and implement the insights. The present invention provides systems and methods for quickly and efficiently rebalancing individual accounts to effect changes to the accounts according to portfolio manager insights.

A model portfolio can consist of a list of securities, along with numbers representing percentage allocations to each security. For example, a model may consist of the following list: {(IBM, 10%), (GE, 10%), (MSFT, 10%), (MO, 10%), (NKE, 15%), (T, 20%), (ITG, 25%)}. The security identifier need not be a ticker but could also be any unique identifier including CUSIP, ISIN, Valoren, SEDOL, a combination of Issuer and Coupon, etc. The model portfolio need not be described solely as a list of securities plus percentage allocations and may also include securities listed by unique characteristics. For example, one asset might be describes as “bonds issued by Corporations with a Moody's Rating Aal or better, with a Duration of at least 3 years but less than 5 years, with a coupon of 8.6%.” The model portfolio may also include suggestions for a particular distribution of asset classes or of specific mutual funds or alternative investment products for accounts following the model to hold.

Individual accounts can be rebalanced for several reasons. Three particular reasons are: (1) the portfolio manager makes an insight triggering rebalancing of the accounts, or (2) an account drifts out of alignment with the master portfolio over time due to application of restrictions, or due to security price fluctuations, or to changes in other security characteristics, or (3) the account holder requests certain services, like withdrawal or depositing of cash, or harvesting of tax losses or gains. Portfolio rebalancing is complicated by the fact that, for separately managed accounts, each account may have specific restrictions or rules associated therewith restricting the type and quantity of holdings in the portfolio.

Restrictions can take several forms. Without limiting the set of possible restrictions, several common ones are listed here: a requirement not to buy a security, a requirement not to accumulate more of a security, a requirement not to hold a security, a requirement not to sell any holdings of a particular security, a requirement not to sell specific tax lots of a holding of a particular security, a requirement not to reduce holdings of a specific security below a certain percentage of the account's holdings, or a requirement not to increase holdings of a specific security above a certain percentage of the account's holdings. Similar restrictions can be placed on a particular group of securities (a “security list”), on the specific industries or groups of industries associated with the securities in the account, on the specific sectors or groups of sectors associated with the securities in the account, or on any number of arbitrary characteristics associated with a given security. For example, when considering fixed income securities, a restriction can be created requiring that the credit quality must be above a certain level.

Restrictions themselves are complicated by the fact that, when created, restrictions may have an “action” that indicates what to do with the amount that was restricted. If a model portfolio recommends holding a security but there is a restriction against that security in the account that follows the model, then when it comes time to rebalance that account the percentage of the model originally allocated to the restricted security (the “weighting”) must be redistributed to alternative securities.

The mechanism by which the weighting is redistributed to alternative securities is usually specified in the restriction itself. These mechanisms may include without limitation “leaving in cash,” “prorating to sector,” or “prorating to industry,” or other similar prorating mechanisms.

“Leaving in cash” means to add the weighting percentage that would otherwise have been associated with the security being restricted to the cash weighting specified in the model.

“Prorating to sector” means to allocate the weighting percentage that would otherwise have been associated with the security being restricted to those securities in the model that are in the same sector as that which was associated with the security that is being restricted. The allocation can be weighted based on any of various techniques, including using the percentages specified in the model for the securities that will receive the prorating, or allocating equally, based on counting each security that will receive the prorating just once, rather than based on the model percentages.

“Prorating to industry” is similar to prorating to sector, except that the restricted security's industry is used instead of its sector. There are several similar prorating methods based on arbitrary lists of securities, or based on specific security characteristics.

Rebalancing accounts is not an instantaneous process. Typically, although the desired outcome of a rebalancing session is that many thousands of accounts are rebalanced, each account is still handled one at a time. The account holdings and the investment strategy must be loaded by a software program from a database into the computer's dynamic memory along with the restrictions on the accounts. Security-level information like prices, coupons, or risk factors also must be loaded by the software into memory. All of this information is then typically compiled together by a software program and compared by the computer against the security holdings specified in the pure “model” that was put together by the portfolio manager. The differences are calculated, and for account positions that hold less than a specific security (or security represented by characteristics) than were specified by the portfolio manager in the model, the computer creates a “buy” order for the security which it stores in the database. For account positions that hold more of a specific security (or security represented by characteristics) than were specified by the portfolio manager in the model, the computer creates a ‘sell’ order for the specific security and, additionally, adds to the sell order an indication as to which specific tax lot or tax lots should be sold. The specific tax lot can be decided by a variety of algorithms, including highest-cost first-out (HCFO), last-in first-out (LIFO), first-in first-out (FIFO), based on specific purchase dates (“versus purchase”), based on minimal tax algorithms, or left to a trader's discretion. This one-at-a-time rebalance process is relatively slow compared to the higher speed process described below.

In order to achieve scalability while rebalancing thousands of accounts at a time and still respecting account-level restrictions and compliance rules, a mechanism called “sub-models” has been developed. Sub-models are similar to models or benchmarks that any account may follow for its investment strategy, with the exception that sub-models incorporate the restrictions for the individual accounts themselves into the actual security weightings described in the sub-model. These restrictions are incorporated during sub-model construction.

For example, an investment model may suggest that accounts in a portfolio hold 10% IBM, 10% MSFT, 30% GE, and 50% MO. If there is a restriction at an account level that prevents an account from holding any tobacco companies, the sub-model constructed for that account would result in holdings of 20% IBM, 20% MSFT, 60% GE, and 0% MO. The MO allocation is set to zero because of the restriction and the quantity of MO is shifted to the other holdings in the sub-model. The shifting of holdings could be prorated based on weights allocated to other securities in the model or based on sectors, industries, or other arbitrary mechanisms.

Many thousands of accounts may share a single set of restrictions (for example, a “no-sin-stock” set of restrictions), and thus, the present invention can achieve scalability by loading sub-models and applying the sub-models to the corresponding accounts rather than repeatedly loading the model and calculating how the model varies with restrictions for each individual account.

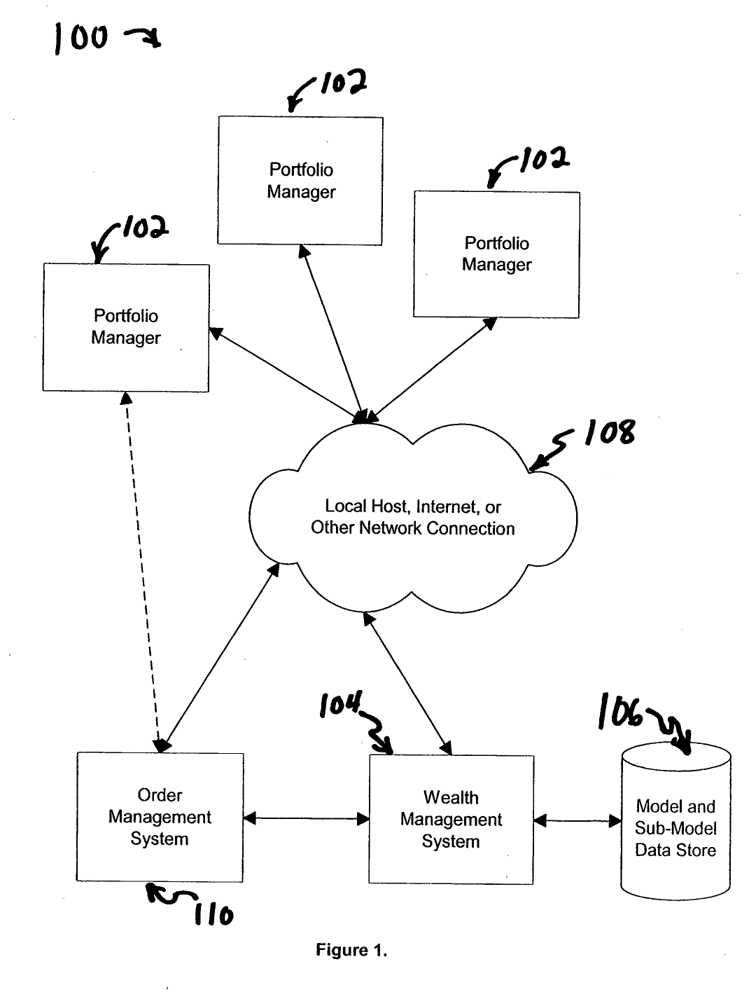

FIG. 1 is a block diagram of a system for using sub-models to rebalance individual investment accounts according to an embodiment of the present invention. System 100 includes a plurality of portfolio manager systems 102, a wealth management system 104, a data storage facility 106, which may includes a model and sub-model database, and an execution management system 110, each of which is coupled with an electronic data network such as the internet 108.

Portfolio manager systems 102 can be client graphical user interfaces (GUI) comprised of a number of forms for receiving and managing data relating to a plurality of portfolios, individual accounts, etc., in accordance with the present invention. As will be described in further detail below, a portfolio manager system 102 can be configured to interact with wealth management system 104 in order to rebalance a plurality of individual accounts in accordance with one or more insights made by a portfolio manager. Wealth management system 104 can be coupled with the model and sub-model data store 106 that stores relevant data necessary for performing the functions and process steps described in this document. Further, as described in additional detail below, the system is capable of generating one or more trades in order to effect portfolio rebalancing. Accordingly, wealth management system 104 or portfolio manager system 102 can be coupled with an execution or order management system 110 for generation and transmission of orders to a trading forum (e.g., ECN, ATS, etc. (not shown)).

According to an embodiment of the present invention, the system can construct a sub-model by first loading the definition of the top level model portfolio from data facility 106. Restrictions can either be processed one at a time or as a group. If restrictions are processed one at a time, presorting can be performed to prevent conflicts created by overlapping restrictions (for example, a restriction that prorates to a sector restricted against by another restriction). When processed one at a time, if the security that is restricted by the restriction exists in the model, the weighting for that security is modulated as specified in the restriction and, if applicable, the resulting weighting is prorated as specified in the restriction's action. This is then repeated for all restrictions, which are processed in the order specified by the presorting. Afterwards, the resulting sub-model consists of an altered list of securities and weightings, and can be substituted for a model portfolio wherever one is required.

If processed as a group, restrictions can be handled in individual groups that all affect each other, or encoded as a set of constraints or equations and then run through an algorithm that satisfies all constraints simultaneously, for example a linear simplex optimizer or other constraint solving algorithm. The resulting sub-model is then a list of securities and weightings that is likely altered from that of the original model, yet which can be substituted for a model portfolio wherever one is required.

According to one embodiment of the present invention, if a sub-model has been created from a model, and then that model subsequently changes (e.g., because of an investment insight), there are two ways to reconstruct the sub-model. The sub-model can be reconstructed from scratch by discarding the existing sub-model and following the outline described above to create a new sub-model, or the change/changes in the model can be “propagated” to the sub-model. Propagation works by loading the affected restrictions and processing them in a manner similar to the processing used to create the original sub-model, thus creating a revised list of changes that are subsequently applied to the existing sub-model. Propagating changes in a model down to a sub-model may or may not follow the exact process as was used to create the original sub-model, depending on the nature of the specific restriction. Certain restrictions can be applied at any point in the process, and some must be applied in a specific order. The order in which a restriction is applied depends on associativity and commutativity properties of the restriction, and on the algorithm chosen for a priori submodel construction.

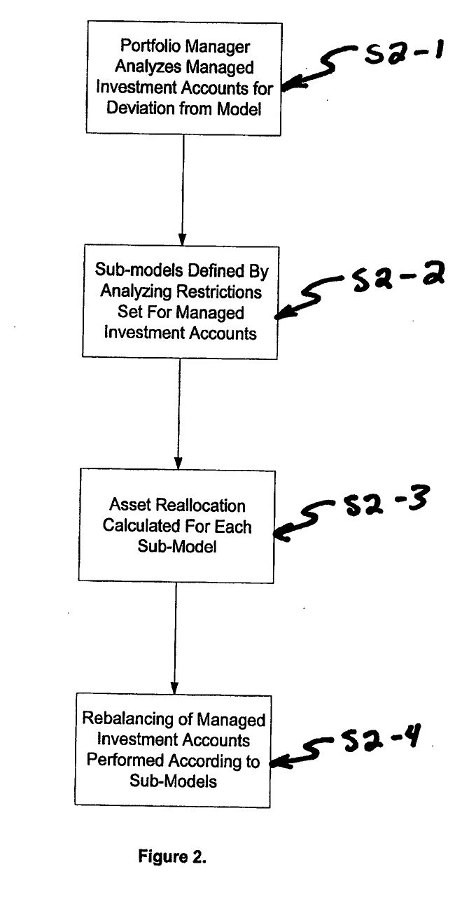

FIG. 2 is a flow chart of a process for performing features of the present invention. Processing begins at step S2-1 wherein it is determined if individual investment accounts deviate from the model. In the next step S2-2, sub-models are defined by analyzing the restriction set for each of the managed investment accounts. Sub-model data can be stored in a variety of formats such as, for example, in a relational database. The sub-models are associated with the one or more accounts upon which they are based. In step S2-3, asset reallocation is calculated for each of the sub-models affected by the change in the model. During this step, the individual accounts are rebalanced based on the sub-model collectively as a group, thereby increasing efficiency. Next step S2-4, a plurality of trade orders, are generated and executed in order to effect the asset reallocation defined by step S2-3.

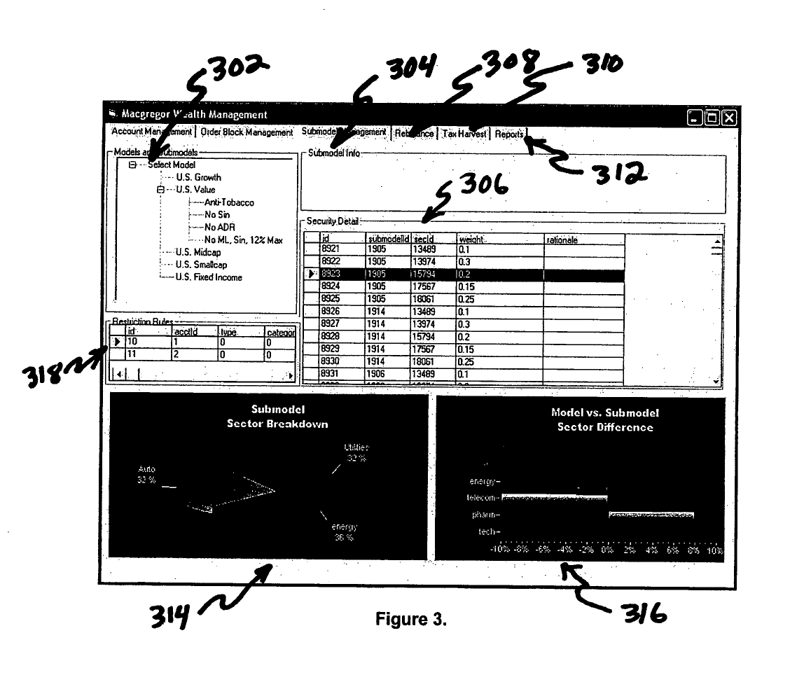

FIG. 3 is a screenshot of an exemplary interface of a system for managing models and sub-models that may be part of a system according to an embodiment of the present invention. Form 300 includes a number of tabs along the top, each of which define different detailed blocks including form fields which display and/or allow entry of data, for example, sub-model management. This exemplary interface includes a tree view 302 that shows all models available, as well as all existing sub-models that have been created relative to a particular model. Because sub-models can be shared across accounts, there is a provision for editing sub-model properties (such as name).

By selecting a particular model or sub-model, the graphs displaying the sector breakdown 314 and sector difference 316 are updated to display that sub-model, as is the representation 318 of the restrictions that go into making up that sub-model. The securities and relative weights of securities are also displayed 306 and change as one navigates the sub-models. As models and sub-models change throughout the system, updates are sent to this screen so that it can always show the most up to date information. It is possible to edit model positions directly within this screen, and the user is able to propagate these changes to the sub-model directly from this screen. The user is able to select a number of different kinds of graphs to display (e.g. sector breakdown, sector difference, industry breakdown, asset type breakdown, individual securities, etc).

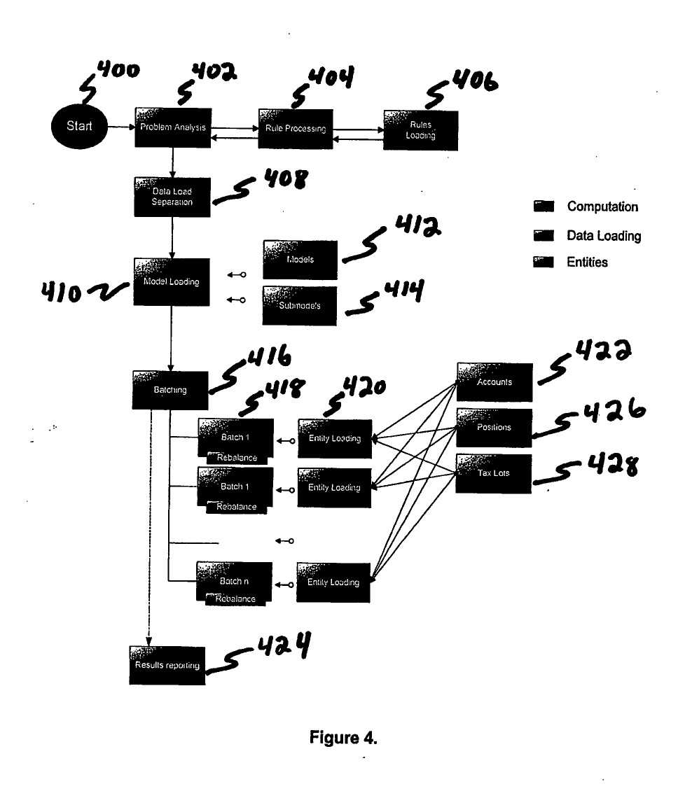

FIG. 4 is a logical process flow diagram representing processing performed in the system and method of the present invention according to an embodiment thereof. The logical process flow depicted here includes computational processes, data loading processes, and data entities.

Data process flow begins at 400 and proceeds to problem analysis process 402. Problem analysis process 402 interacts with a rule process 404 which in turn interacts with rules data 406. The problem analysis process 402 outputs data to a data load separation process 408 which outputs to the model loading process 410. The output from model loading process 410 is input into a batching process 416. In batching process 416, accounts 422, positions 426, and tax lots 428 are loaded via entity loading processes 420 into rebalancing batches 418. Batch processes thereby apply the model and sub-models to the individual accounts in each batch, and the results are output to results reporting 424.

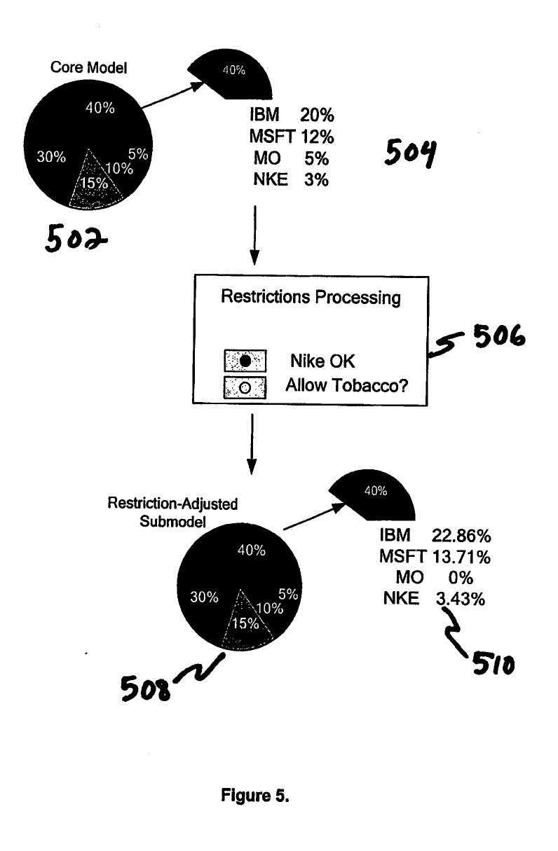

FIG. 5 illustrates generation of a restriction-adjusted sub-model from a core model (e.g., top-level portfolio model). The core model 502 includes a number of account holdings. In this example, one account holding amounts to 40% of the portfolio and comprises 20% IBM, 12% MSFT, 5% MO, and 3% NKE. Restrictions 506 are applied to the core model. Restrictions 506 includes a restriction allowing purchase of Nike stock (NKE) but prohibiting purchase of tobacco stocks (such as MO). Accordingly, no purchasing of MO is allowed by restrictions 506. According to an embodiment of the present invention, a core model is adjusted to allocate equally the 5% holdings of MO amongst the three equities in order to arrive at the sub-model defined as IBM 22.86% MSFT 13.71% and NKE 3.43% adding up to the original 40%.

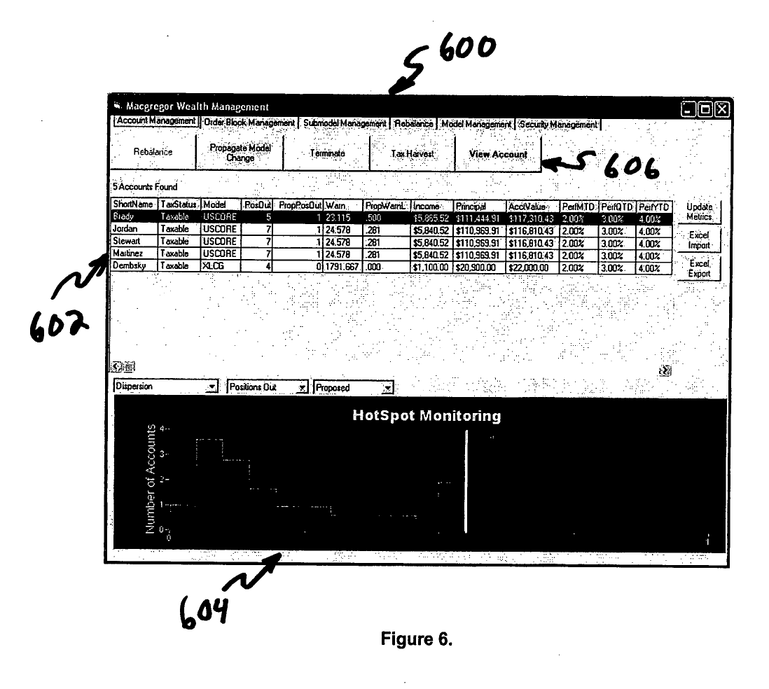

FIG. 6 is a screenshot of an exemplary user interface for a system that allows users to view accounts by deviation from their model/sub-model according to an embodiment of the present invention. Various clients (i.e. portfolio managers) have vastly differing numbers of accounts under management. This number can range from a few hundred to upwards of seventy thousand in a typical case, with upwards of one million accounts not out of range for certain systems. Portfolio managers need a “bird's eye” view of how all their accounts are performing.

Form 600 screen provides the bird's eye view. Users can view accounts by deviation from their model/sub-model, by YTD gain/loss, by performance, and by a number of other metrics. This view is composed primarily of a grid 602 and the HotSpot Monitor 604. The HotSpot Monitor 604 shows a graphical view of the information/metric selected for display. This graphical view provides a histogram or spectrum of metrics for all or subsets of accounts. Subsets of accounts can be chosen by using specific filters or ‘slices’ representing common account characteristics. The user can click on various parts of this display (the red and green sections) to select which accounts are listed within the grid. Columns within the grid are sortable and groupable by various mechanisms (forward and reverse sorting, using a tree, using date-ranges or category groupings, etc). The grid shows relevant account information, and provides a mechanism for the user to drill down into the Single Account Management screen, by double-clicking on a row or clicking the View Account button 606. The user can also select a range of rows for rebalancing, tax harvesting, to propagate model changes, or perform other investment or account maintenance actions.

A wealth management system according to one embodiment of the present invention provides an SMA-specific set of restrictions that can be placed on an account. This set of restrictions can be carefully designed to allow for the creation of sub-models based on these restrictions. A restriction management mechanism is provided within the interface of the system.

A rebalance can be done on one, dozens, hundreds or thousands of accounts at once. Various kinds of rebalances can be performed, including without limitation a “violators” rebalance, a full rebalance, an asset allocation rebalance, a duration rebalance, or rebalance of other account or security level characteristics. A full rebalance will attempt to bring an account completely in line with a model. A violators rebalance will only issue correcting orders for accounts that are outside of a certain ‘band’, measured relative to a model. After selecting particular accounts in the account monitoring screen, the user can launch the rebalance tool. Alternatively, rebalance can be launched while viewing a single account. When rebalancing a single account, positions that deviate from the model are shown in a grid on the screen. If the user changes the number of violators to display, or changes the violator band, the grid will be updated accordingly to show those positions which will be considered for rebalancing. When selecting multiple accounts, this grid showing positions for a single account is not displayed. When the rebalance is launched, the progress monitor is updated continuously. As information comes back and particular batches are finished, the graph will update to show a decrease in the number of accounts remaining to be rebalanced, and a (probable) increase in the number of orders generated. At any time, the user can halt an ongoing rebalance. When a rebalance is finished or halted, a summary report can be viewed or actual generated orders can be viewed. In the present system, there is no ‘undo’ functionality, however orders that were generated are generated in a ‘proposed’ state and can be subsequently cancelled.

According to an embodiment of the present invention, the system of the present invention can include one or more of the following subsystems:
Batching and dynamic monitoring capabilities—used by rebalance and multiple tax harvest to group together large operations that can be applied to thousands of accounts at a time.
Hotspot monitor—used to display a summarization of metrics across thousands of accounts, providing a high-level view of divergence and exposure.
Sub-models—these provide an efficient mechanism to provide pre-trade compliance, by building restrictions into a model. These speeds calculations, and allows the user to see divergence (using the HotSpot Monitor) relative to the restriction-adjusted sub-model, rather than just relative to a model.
Order Bundles—In order to accommodate the huge volume of orders that can be created by functional actions within XWM (e.g. violators rebalance, propagate model change), XWM provides a mechanism to bundle orders by various characteristics of an order, including ticker, side, date, and broker. These are then exported to a trading system for trading under an ‘omnibus’ account, and allocations that come back are handled within XWM, wherein they are distributed to the appropriate accounts by various allocation methods (including without limitation account size, order size, unfilled order amount, randomly, etc.).
Business Services—These are XWM-specific business capabilities, including rebalance, tax harvest, and so on.
Graphs—a graphing control by a third-party provider has been used in the present invention for all bar, line and pie chart displays.
   Business Service Priority Negotiation

Different business services have more or less priority for particular users. For example, a trader may care much more about getting her order fills back than she does about having the portfolio manager's rebalance finish. If the portfolio manager is the one calling the decisions, however, they expect the rebalance to take priority. This is similar to a scheduler in many ways, in that priorities are dictated by a policy that is set for each firm. This policy is then read and interpreted by the priority negotiation service to determine which services should be given priority in execution.

The tax lot selection method, used by rebalance (and by propagate model change), can either be LIFO, FIFO, HCFO, or our own customized tax algorithm. This algorithm has been extensively tested and typically provides better results than any of the standard, easier to calculate methods like LIFO/FIFO.

Model Management

Model management within the example system includes the following features: 1) basic editing capabilities for adding and removing securities and for changing weights, and 2) some provision for higher level changes, like editing weights at an aggregate level (like by sector or industry) and having these weight changes propagated to the underlying positions.

Sub-Model Management

Sub-models can be created, managed and refreshed via this service. Sub-models are based on restrictions, as specified above, and provide several capabilities to the XWM module. Sub-models provide a specialized pre-trade compliance capability that allows the rebalance algorithm to execute at high-speed. They also allow the account monitor to rapidly switch between showing account deviation from a model, or from a restriction-adjusted sub-model. Sub-models are also useful in the implementation of more specialized restriction types, particularly for use in fixed income implementations.

Scalability Plane/Scalability Mitigation Layer

According to embodiments of the present invention, .NET remoting is employed with possible load balancing via Network Load Balancing (NLB) on Windows Advanced Server. If additional services are required that are not provided by .NET remoting, the servers can be accessed via this plane—calls from the UI's Base Component Manager are directed to a server side process running the scalability plane, which in turn further directs calls to where they need to go.

The present invention is not limited to a single-pass rebalance. According to another embodiment, the present invention can also be applied to a multi-pass rebalance, or a multi-asset class rebalance. In the case of multiple asset classes, a rebalance may make use of a hierarchy of sub-models, rather than a single sub-model. This involves using a sub-model to specify a distribution of percentages specifying a portfolio's asset classes (or investment styles, or currency holdings, or other grouping). Each such grouping would be called a ‘sleeve’. Then within each sleeve, traditional security descriptors can be used with percentage allocations indicating (relative to the total sleeve) how much of each security to hold. Accounts may be rebalanced either to this hierarchy of sub-models (rebalancing first to sleeves, and then to individual security holdings), or they can be rebalanced to a blended sub-model that takes the highest-level allocation percentages and multiplies them by the individual holdings at the sleeve level, to give a final percentage. If this latter approach is pursued, individual security names in the different sleeves that overlap must be added together to achieve the ‘blending’.

As an example, consider an account that holds 20% Large Cap Growth, 10% Large Cap Value, 10% Mid Cap, 10% International, and 50% Fixed Income. Suppose that the Large Cap Growth sleeve is in turn made up of 30% MSFT, 40% IBM, 5% MO, and 25% ITG, and the Large Cap Value is made up of 50% AA, 10% ITG, 5% C, and 35% T. Assume the Mid Cap, International, and Fixed Income sleeves all hold a single mutual fund. In this case, ITG is held in both the Large Cap Growth and Large Cap Value sleeves. Sub-models can be either 1) constructed individually for both the top-level allocation to sleeves (Large Cap Growth, Large Cap Value, Mid Cap, International, Fixed Income) and individually for each sleeve (Large Cap Growth=MSFT, IBM, MO, ITG), or 2) constructed as a blended sub-model. Here, the star character (‘*’) represents multiplication:

20% Large Cap Growth*(MSFT,IBM, MO, ITG)

10% Large Cap Value*((AA, ITG, C, T)

10% Mid Cap*(mid-cap mutual fund)

10% International*(international mutual fund)

50% Fixed Income*(fixed income mutual fund)

Results in:

6% MSFT

8% IBM

1% MO

5% ITG

5% AA

1% ITG

0.5% C

3.5% T

10% mid-cap mutual fund

10% international mutual fund

50% fixed income mutual fund

Since ITG is repeated twice, the percentages are added to get a final distribution:

6% MSFT

8% IBM

1% MO

5% ITG+1% ITG=6% ITG

5% M

0.5% C

3.5% T

10% mid-cap mutual fund

10% international mutual fund

50% fixed income mutual fund

Thus, a number of preferred embodiments have been fully described above with reference to the drawing figures. Although the invention has been described based upon these preferred embodiments, it would be apparent to those of ordinary skill in the art that certain modifications, variations, and alternative constructions could be made to the described embodiments within the spirit and scope of the invention.

Sub-models also allow for more efficient monitoring of large numbers of accounts by allowing analysis of account drift according to both restrictions associated with the account as well as the account's master model portfolio, rather than solely relative to the account's master model portfolio without incorporating the account's restrictions.

We claim:

1. A system for rebalancing a portfolio comprising a plurality of individual investment accounts, each individual investment account holding at least one of tradeable assets and cash, said system comprising:
a data storage facility configured to store data defining each of said plurality of individual investment accounts and restrictions on each of said plurality of individual investment accounts;
a modeling facility configured to receive an investment model and to generate one or more adjusted models based upon said investment model and said restrictions in said data storage facility and to associate each adjusted model to one or more corresponding individual investment accounts; and
a rebalancing facility configured to rebalance account holdings in said individual investment accounts based upon corresponding adjusted models from said modeling facility.

2. The system according to claim 1, wherein said restrictions include rules defining name and quantity of assets that can be held by an individual account.

3. The system according to claim 1, wherein:
said data storage facility stores investment strategy data defining a common set of rules for a first group of said individual investment accounts;
said modeling facility is further configured to generate a first adjusted model based upon said investment model and said investment strategy and to associate said first adjusted model with each of said first group of individual accounts; and
said rebalancing facility configured to rebalance each of said individual investment accounts in said first group based upon said first adjusted model.

4. The system according to claim 1, wherein said rebalancing facility generates one or more trade orders for an individual investment account being rebalanced which, if executed, would adjust the holdings in said individual investment account being rebalanced to match the corresponding adjusted model.

5. The system according to claim 1, wherein said restrictions include rules defining tax restrictions on corresponding individual investment accounts.

6. The system according to claim 1, wherein said modeling facility further comprises:
a first component for identifying proposed holdings in said investment model restricted by a first restriction on an individual investment account;
a second component for generating said adjusted model by distributing the proposed holdings identified by said first component even across remaining proposed holding in said investment model; and
a third component for identifying a group of individual accounts each having said first restriction being applied thereto and associating said adjusted model with each individual investment account in the identified group.

7. A computer implemented method for rebalancing portfolios held by a plurality of individual investment accounts, each individual investment account holding at least one of either tradeable assets or cash, said method comprising steps of:
storing data defining each of said plurality of individual investment accounts;
storing data defining zero or more restrictions on each of said plurality of individual investment accounts;
receiving data defining an investment model;
generating one or more adjusted models based upon said stored data defining the investment model and the restrictions;
associating each adjusted model to one or more corresponding individual investment accounts; and
rebalancing account holdings in said individual investment accounts based upon corresponding adjusted models from said sub-modeling facility.

8. The method according to claim 7, wherein said restrictions include rules defining aspects of assets that may be held by an individual account.

9. The method according to claim 7, further comprising steps of:
storing investment strategy data define a common set of rules for a first group of said individual investment accounts;
generating a first adjusted model based upon said investment model and said investment strategy;
associating said first adjusted model with each of said first group of individual accounts; and
rebalancing each of said individual investment accounts in said first group based upon said first adjusted model.

10. The method according to claim 7, further comprising a step of generating one or more trade orders for an individual investment account being rebalanced which, if executed, would adjust the holdings in said individual investment account being rebalanced to match the corresponding adjusted model.

11. The method according to claim 7, wherein said restrictions include rules defining one or more tax restrictions on corresponding individual investment accounts.

12. The method according to claim 7, further comprising steps of:
identifying proposed holdings in said investment model restricted by a first restriction on an individual investment account;
generating said adjusted model by distributing the proposed holdings identified evenly across remaining proposed holdings in said investment model; and
identifying a group of individual accounts each having said first restriction being applied thereto;
associating said adjusted model with each individual investment account in the identified group.

13. A method of rebalancing a plurality of managed investment accounts based on an investment model, each of said investment accounts including a portfolio of assets and having zero or more restrictions associated therewith, said method comprising steps of:
associating at least one sub-model to a group of said plurality of managed investment accounts, the at least one sub-model defining a group of restrictions that are common to said group of managed investment accounts;
receiving an investment model defining an adjustment of a master portfolio; and
rebalancing each of said group of managed investment accounts based upon said investment model and said at least one sub-model.

14. The method as recited in claim 13, wherein said sub-model is defined automatically for said managed investment accounts.

15. The method as recited in claim 13, wherein said sub-model is defined by setting particular restrictions based upon characteristics of said assets.

16. The method as recited in claim 13, wherein changes to said investment model are propagated to said sub-models.

17. A system for rebalancing a plurality of managed investment accounts based on an investment model, each of said investment accounts including a portfolio of assets and having zero or more restrictions associated therewith, said system comprising:
means for associating at least one sub-model to a group of said plurality of managed investment accounts, the at least one sub-model defining a group of restrictions that are common to said group of managed investment accounts;
means for receiving an investment model defining an adjustment of a master portfolio; and
means for rebalancing each of said group of managed investment accounts based upon said investment model and said at least one sub-model.

18. The system as recited in claim 17, wherein said sub-models are defined by automatically analyzing said plurality of managed investment accounts.

19. The system as recited in claim 17, wherein said sub-models are defined by setting particular restrictions based upon characteristics of particular assets.

20. The system as recited in claim 17, wherein changes to said model are propagated to said sub-models.

21. The system as recited in claim 17, wherein said adjusted models allow analysis of accounts to indicate account drift relative to account restrictions.
